(19) United States
(12) Patent Application Publication
(10) Pub. No.: US 2008/0316173 A1
(43) Pub. Date: Dec. 25, 2008

(54) Computer cursor control device which can broadcast multimedia data

(76) Inventor: Hung-Ming Tsai, Chung Ho City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/812,828

(22) Filed: Jun. 22, 2007

(51) Int. Cl. G06F 3/033

(52) U.S. Cl. 345/163

(57) ABSTRACT

A computer cursor control device is disclosed which can broadcast multimedia and control a computer cursor and comprises an interface unit; a mouse module connecting to the interface unit and controlling the computer cursor in a mouse mode; a multimedia module connecting to the interface unit and accessing a multimedia file in a multimedia mode for further broadcasting the multimedia file; and a button control unit connecting to the mouse module and the multimedia module respectively which enters a control signal for controlling the computer cursor or broadcasting the multimedia file.

### BACKGROUND OF THE INVENTION

1. Field of the Invention

The present invention relates to a computer cursor control device, and more particularly to a computer cursor control device which can broadcast multimedia data.

2. Description of the Prior Art

In the current era, almost everyone owns a computer, wherein a computer mousse is a main element of a computer. Computer mice include various kinds such as optical types, wheel types, etc.

In Taiwan patent No. 175151, a computer mouse includes a speaker that connects to a sound card of a computer via an audio transmission line. Hence, the computer can transmit audio signals produced by the sound card to the computer mouse via the audio transmission line for further broadcasting audio signals via the speaker.

In Taiwan patent No. 175644, a computer peripheral performs the functions of a computer mouse. Moreover, the computer peripheral transmits audio signals to a computer via a USB transmission line for further broadcasting audio signals.

In Taiwan patent No. 111329, a remote controller can perform the functions of a wireless computer mouse and a wireless telephone.

Such prior art computer mice and devices can control a computer cursor and also provide other functions. However, the prior art computer mice and devices can not work independently. The prior art computer mouse and devices have to work with or near the computer. Hence, it is inconvenient for users to use such devices.

### SUMMARY OF THE INVENTION

It is the object of the present invention that the computer cursor control device of the present invention can both control a computer cursor and also broadcast multimedia files.

It is another object of the present invention that the computer cursor control device can simultaneously work in a mouse mode and a multimedia mode.

It is another object of the present invention that the computer cursor control device can selectively work in a mouse mode or a multimedia mode.

In order to achieve the above objects, the present invention provides a computer cursor control device that can broadcast multimedia that comprises an interface unit, a mouse module connected to the interface unit and controlling a computer cursor in a mouse mode, a multimedia module connecting to the interface unit and accessing and broadcasting multimedia files in a multimedia mode, a button control unit connecting to the mouse module and the multimedia module and inputting a control signal for further controlling the computer cursor or broadcasting multimedia files.

In the first embodiment of the present invention, in order to simultaneously work in mouse mode and multimedia mode, the button control unit provides two kinds of control buttons for the two modes. The interface unit further provides a hub used for connecting to a computer so that the computer cursor control device can transmit signals to the computer for further controlling the computer cursor.

In the second embodiment of the present invention, in order to work in either the mouse mode or the multimedia mode, the button control unit provides not only common control buttons for the two modes, but also a function selector. Hence, the computer cursor control device can switch operating modes between the two modes via the function selector and control the computer cursor and broadcast or access multimedia files via corresponding control buttons.

In the third embodiment of the present invention, in order to work in either the mouse mode or the multimedia mode, the interface unit provides an audio transmission interface or a card reader interface to switch between the two operating modes. Hence, the computer cursor control device can select one of the operating modes according to whether an audio broadcaster connects to the audio transmission interface or a memory card connects to the card reader interface.

### BRIEF DESCRIPTION OF THE DRAWINGS

The above and further advantages of this invention may be better understood by referring to the following description, taken in conjunction with the accompanying drawings, in which:

FIG. 1 is a block diagram of the computer cursor control device of the present invention;

FIG. 2 is a status diagram of the computer cursor control device of the present invention working in mouse mode;

FIG. 3 is a status diagram of the computer cursor control device of the present invention working in multimedia mode;

FIG. 4 is a block diagram of the computer cursor control device of the first embodiment of the present invention; and

FIG. 5 is a block diagram of the computer cursor control device of the second embodiment of the present invention.

FIG. 6 is a block diagram of the computer cursor control device of the third embodiment of the present invention.

FIG. 7A-7C are circuit structures of the computer cursor control device of the present invention.

The drawings will be described further in connection with the following detailed description of the present invention.

### DETAILED DESCRIPTION OF THE PREFERRED EMBODIMENTS

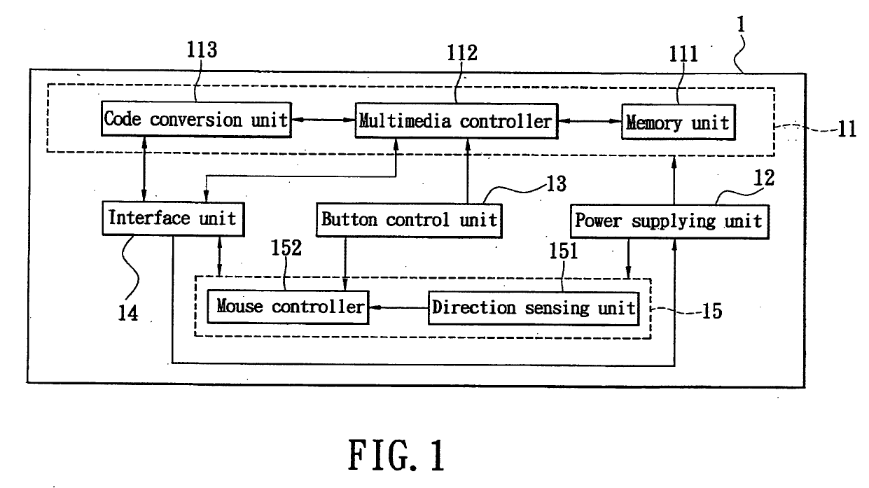

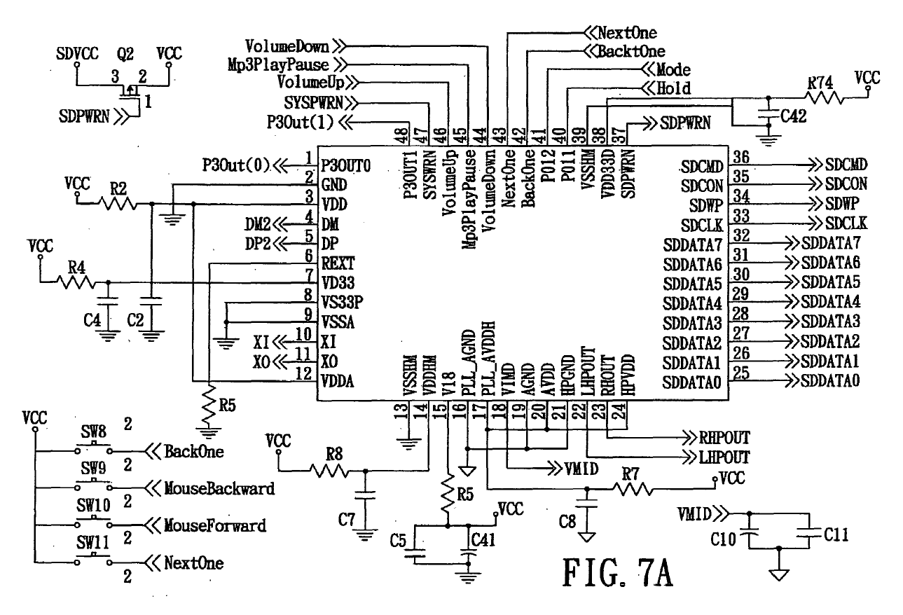

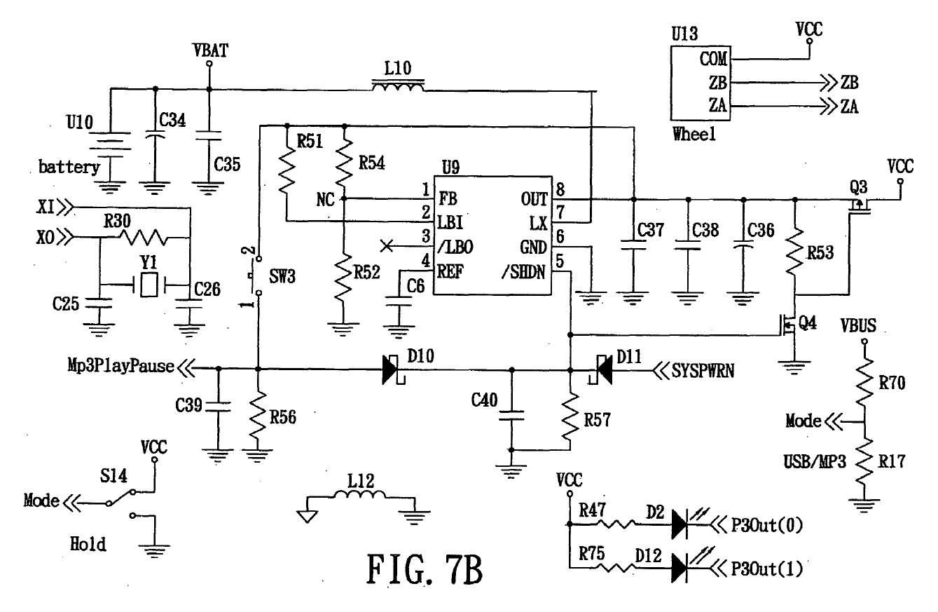

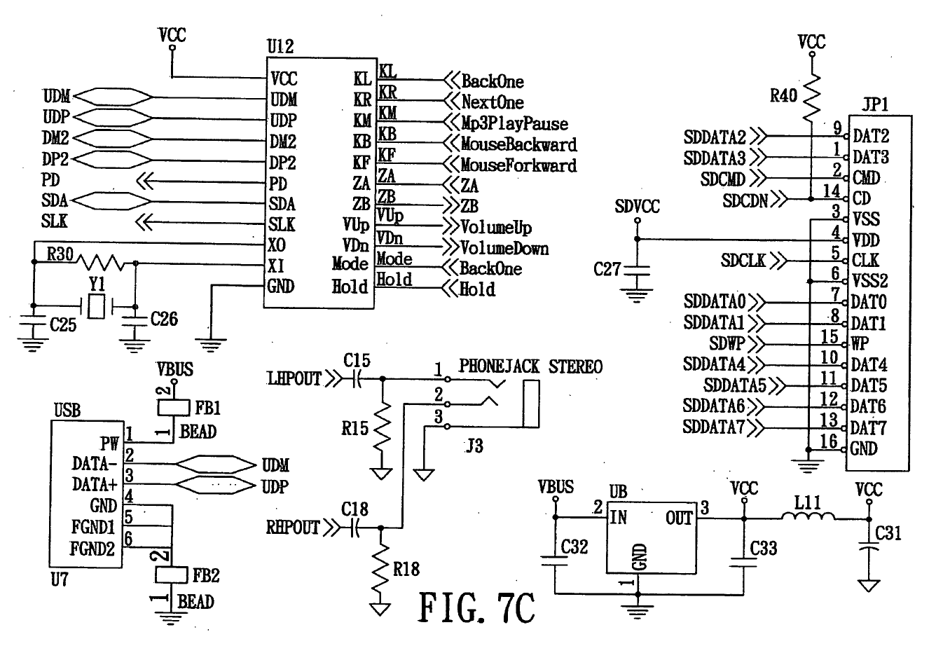

In FIG. 1, a computer cursor control device 1 not only controlling a computer cursor but also broadcasting a multimedia file is shown. The computer cursor control device 1 includes a multimedia module 11, a power supplying unit 12, a button control unit 13, an interface unit 14, and a mouse module 15. The detail circuit structure of the computer cursor control device 1 is shown in FIG. 7A through 7C.

The multimedia module 11 is a music player such as an MP3 player and includes a memory unit 111, a multimedia controller 112, and a code conversion unit 113. When receiving a command for broadcasting multimedia files, the multimedia module 11 enters a multimedia mode, reads multimedia files and then broadcasts the read multimedia files.

The multimedia controller 112 can determine the sources of the multimedia files, such as the memory unit 111, a memory card (not shown), a computer, and so on. The multimedia controller 112 can access a multimedia file from the memory unit 111 if the multimedia file is predeterminately stored in the memory unit 111, from the memory card via the interface unit 14 if the multimedia file is predeterminately stored in the memory card, or from the computer via the interface unit 14 if the multimedia file is predeterminately stored in the computer. When obtaining the multimedia file from one of the above sources, the multimedia controller 112 transmits the multimedia file to the code conversion unit 113 for further encoding and decoding of the multimedia file. Hence, users can listen to the multimedia signal outputted by the code conversion unit 113 when a speaker such as an earphone connects to the interface unit 14.

In addition, the multimedia controller 112 can determine whether a multimedia signal has been inputted to the computer cursor control device 1. For example, when a user wants to record an audio signal via the computer cursor control device 1, the user can input the audio signal to the computer cursor control device 1 via a microphone (not shown). Next, the code conversion unit 113 converts and encodes the audio signal. Finally, the multimedia controller 112 stores the encoded audio signal in the memory unit 111, a computer, or a memory card, wherein the computer or the memory card connects to the interface unit 14.

The power supplying unit 12 converts an external power (not shown) to further supply power to each element of the computer cursor control device 1, such as the multimedia module 11, the mouse module 15, and so on. The source of the external power can be the computer or a battery.

The button control unit 13 provides a control signal from the user, such as a multimedia mode command or a mouse mode command, to control the multimedia module 11 and the mouse module 15. Hence, the multimedia module 11 can transmit signals, record sounds, broadcasting sounds, etc, and the mouse module 15 can control the computer cursor via clicks of a right or left mouse button.

In the first embodiment of the present invention, the button control unit 13 provides two kinds of buttons respectively corresponding to the multimedia mode and the mouse mode. In the second embodiment of the present invention, the button control unit 13 provides common buttons for both the multimedia mode and the mouse mode.

The mouse module 15 includes a direction detection unit 151 and a mouse controller 152, and can control the computer cursor by transmitting a mouse signal to the computer, wherein the computer cursor control device 1 can transmit the mouse signal to the computer in wireless or wired manners. In the first embodiment, the computer cursor control device 1 transmits the mouse signal to the computer via the interface unit 14 connected to the computer in a wired manner. In the second embodiment, the computer cursor control device 1 transmits the mouse signal to the computer via the interface unit 14 connected to the computer in a wireless communication manner.

The direction detection unit 151 detects in real time the movement direction of the computer cursor control device 1 when the user moves the computer cursor control device 1. The direction detection unit 151 can be a scroll ball detector, an optical detector, and so on.

The mouse controller 152 processes signals provided from the button control unit 13 and the direction detection unit 151 for further generating mouse signals. Next, the computer cursor control device 1 transmits the mouse signal to the computer via the interface unit 14 for further controlling the computer cursor.

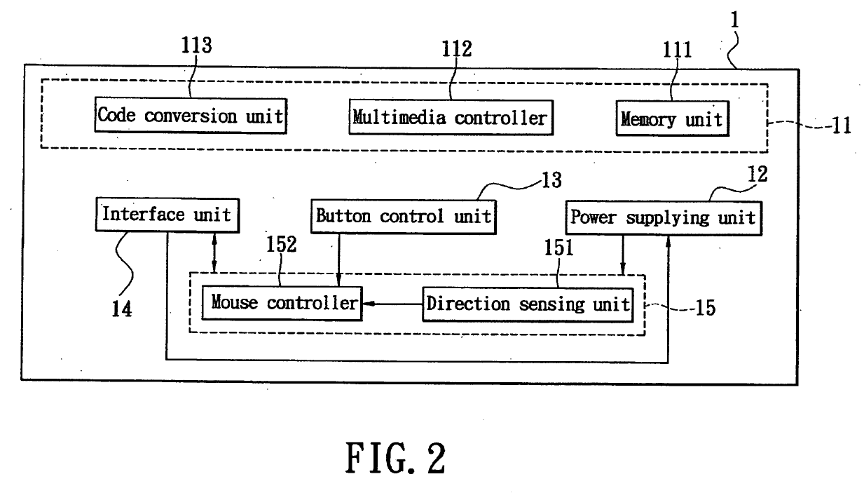

In FIG. 2, a status diagram of the computer cursor control device of the present invention in mouse mode is shown. When the computer cursor control device 1 is operating in mouse mode, the power supplying unit 12, the button control unit 13, the interface unit 14, and the mouse module 15 work, but the multimedia module 11 does not.

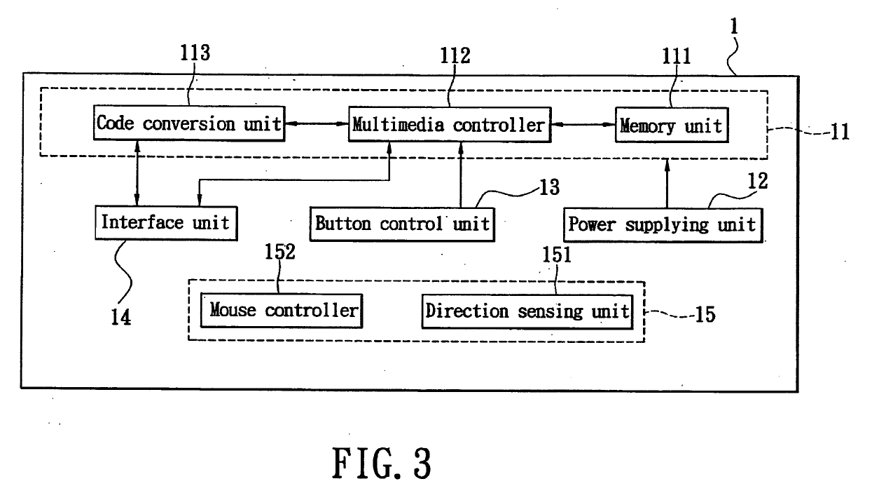

In FIG. 3, a status diagram of the computer cursor control device of the present invention in multimedia mode is shown. When the computer cursor control device 1 is operating in multimedia mode, the power supplying unit 12, the button control unit 13, the interface unit 14, and the multimedia module 11 work, but the mouse module does not.

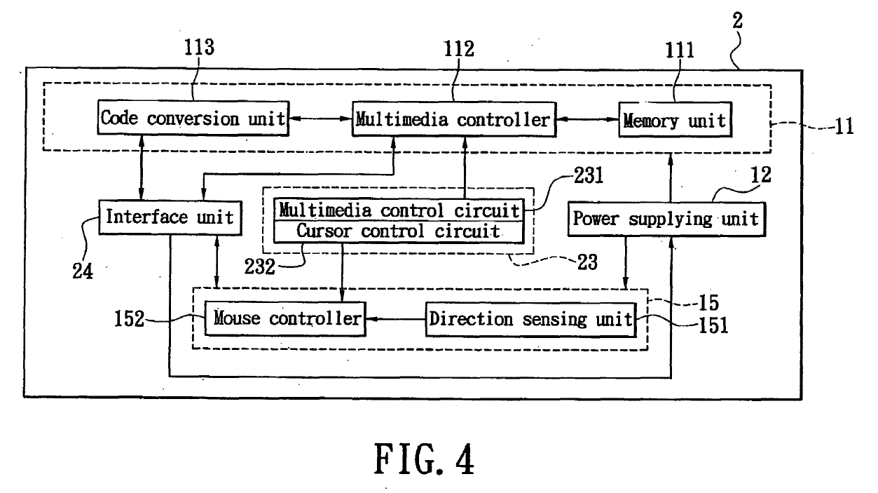

The first embodiment of the computer cursor control device 2 of the present invention is shown in FIG. 4. The computer cursor control device 2 can work in mouse mode and in multimedia mode simultaneously and provide two kinds of buttons for the two modes, such as a multimedia controlling circuit 231 and a cursor control circuit 232. The multimedia controlling circuit 231 can control the multimedia module 11 to broadcast, record, pause, and so on. The cursor control circuit 232 can control the mouse module 15 to control the computer cursor.

In order to ensure that the computer cursor control device 2 can simultaneously work in mouse mode and multimedia mode, the present invention provides a hub such as a USB hub to connect to the computer (not shown). Hence, the multimedia module 11 and the mouse module 15 can transmit signals to the computer based on the timing of the hub.

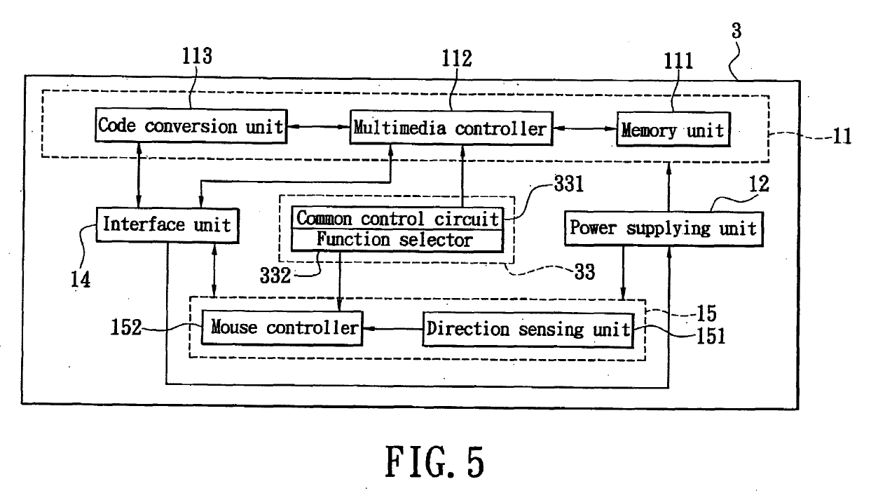

The second embodiment of the computer cursor control device 3 of the present invention is shown in FIG. 5. The computer cursor control device 3 can selectively work in mouse mode and in multimedia mode and provide common buttons for the two modes, such as the common control circuit 331. The common control circuit 331 controls the multimedia module 11 to broadcast, record, pause, and so on in the multimedia mode and controls the mouse module 15 to control the computer cursor in the mouse mode.

In order to ensure that the computer cursor control device 3 can selectively work in mouse mode and in multimedia mode, the present invention provides a function selector 332 to select one of the two modes so that the multimedia module 11 and the mouse module 15 can operate selectively via the function selector 332.

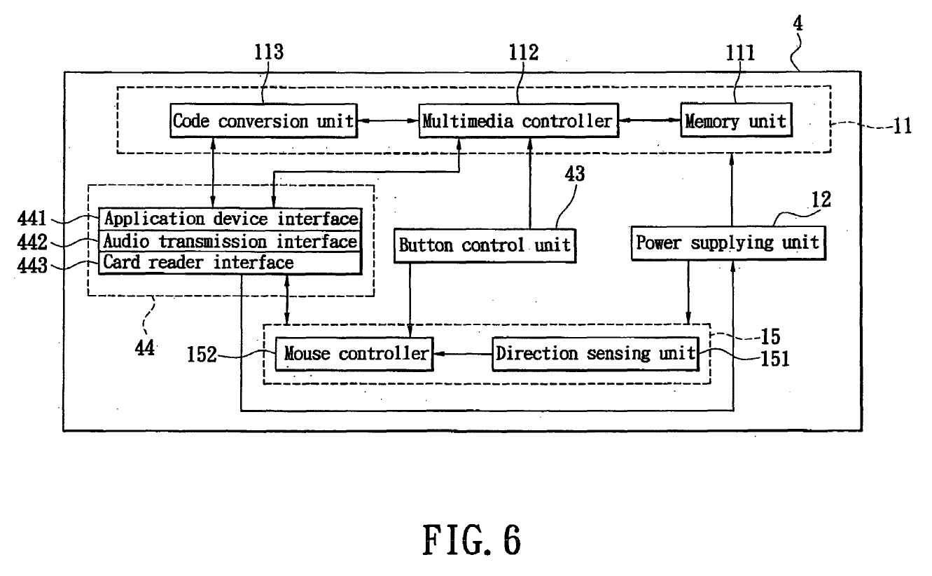

In FIG. 6, the third embodiment of the computer cursor control device of the present invention is shown. The computer cursor control device 4 can selectively work in either the mouse mode or the multimedia mode. The button control unit 43 provides common buttons for the two modes, such as the common control circuit (not shown). The common control circuit controls the multimedia module 11 to broadcast, record, pause, and so on in the multimedia mode and controls the mouse module 15 to control the computer cursor in the mouse mode. Moreover, the computer cursor control device 4 connects to the computer (not shown) via the application device interface 441 for further transmitting signals.

In order to ensure that the computer cursor control device 4 can selectively work in mouse mode and multimedia mode, the interface unit 44 provides an audio transmission interface 442 and a card reader interface 443 to select one of the two modes so that the multimedia module 11 and the mouse module 15 can operate selectively via the audio transmission interface 442 or the card reader interface 443.

When the multimedia controller 112 detects that an audio broadcaster (not shown) has connected to the audio transmission interface 442, the computer cursor control device 4 works in multimedia mode. The multimedia module 11 works, but the mouse module 15 does not. The audio broadcaster can be a speaker or earphones.

When the multimedia controller 112 does not detect an audio broadcast connecting to the audio transmission interface 442, the computer cursor control device 4 works in mouse mode, that is, the computer cursor control device 4 can control the computer cursor through clicking of a right or left mouse button, movement, and so on. The mouse module 15 works, but the multimedia module 11 does not.

Alternatively, if the multimedia controller 112 detects a memory card (not shown) connecting to the card reader interface 443, the computer cursor control device 4 will work in multimedia mode, and the multimedia module 11 will perform multimedia functions, such as broadcasting music, recording sounds, accessing files, and so on. In this case, the mouse module 15 does not work.

If the multimedia controller 112 detects no memory card connecting to the card reader interface 443, the computer cursor control device 4 will work in mouse mode, and the mouse module 15 will work. In this case, the multimedia module 11 does not work.

An advantage of the present invention is that the computer cursor control device of the present invention can not only control a computer cursor but also broadcast multimedia files.

Another advantage of the present invention is that the computer cursor control device can work in mouse mode and multimedia mode simultaneously.

Yet another advantage of the present invention is that the computer cursor control device can selectively work in mouse mode or multimedia mode.

Yet another advantage of the present invention is that the computer cursor control device selects its operating modes via a function selector.

Yet another advantage of the present invention is that the computer cursor control device selects its operating modes by determining whether a multimedia broadcaster has connected to the audio transmission interface.

Yet another advantage of the present invention is that the computer cursor control device selects its operating modes by determining whether a memory card has connected to the card reader interface.

Another advantage of the present invention is that the computer cursor control device works in two modes simultaneously via a hub.

Another advantage of the present invention is that the present invention provides common control buttons for the two modes.

Yet advantage of the present invention is that the present invention provides two kinds of control buttons for the two modes.

The description above only illustrates specific embodiments and examples of the present invention. The present invention should therefore cover various modifications and variations made to the herein-described structure and operations of the present invention, provided they fall within the scope of the present invention as defined in the following appended claims.

What is claimed is:

1. A computer cursor control device capable of broadcasting multimedia and controlling a computer cursor, comprising:
an interface unit;
a mouse module connecting to the interface unit and controlling the computer cursor in a mouse mode;
a multimedia module connecting to the interface unit and accessing a multimedia file in a multimedia mode for further broadcasting the multimedia file; and
a button control unit connecting to the mouse module and the multimedia module respectively and entering a control signal for controlling the computer cursor or broadcasting the multimedia file;
wherein, the computer cursor control device selectively operates in either the multimedia mode or the mouse mode.

2. The computer cursor control device according to claim 1, wherein the interface unit defines whether the computer cursor control device is operating in the multimedia mode or the mouse mode.

3. The computer cursor control device according to claim 1, wherein the interface unit comprises an application device interface for connecting to a computer.

4. The computer cursor control device according to claim 2, wherein the interface unit comprises a card reader interface that determines whether the computer cursor control device is operating in the multimedia mode or the mouse mode.

5. The computer cursor control device according to claim 4, further comprising a memory card connecting to the card reader interface and storing the multimedia file.

6. The computer cursor control device according to claim 2, wherein the interface unit comprises an audio transmission interface that determines whether the computer cursor control device is operating in the multimedia mode or the mouse mode.

7. The computer cursor control device according to claim 1, wherein the button control unit defines whether the computer cursor control device is operating in the multimedia mode or the mouse mode.

8. The computer cursor control device according to claim 7, wherein the button control unit comprises a function selector that determines whether the computer cursor control device is operating in the multimedia mode or the mouse mode.

9. The computer cursor control device according to claim 1, wherein the button control unit comprises a common control circuit used for providing the control signal.

10. The computer cursor control device according to claim 1, wherein the multimedia module comprises a multimedia controller, a code conversion unit, and a memory unit.

11. The computer cursor control device according to claim 10, wherein the memory unit stores the multimedia file.

12. The computer cursor control device according to claim 1, wherein the mouse module comprises a mouse controller and a direction sensing unit.

13. A computer cursor control device performing multimedia broadcast and controlling a computer cursor, comprising:
an interface unit comprising a hub;
a mouse module connecting to the interface unit and controlling a computer cursor in a mouse mode;
a multimedia module connecting to the interface unit and assessing a multimedia file in a multimedia mode for further broadcasting the multimedia file; and
a button control unit respectively connecting to the mouse module and the multimedia module and providing a control signal to control the computer cursor or broadcast the multimedia file;
wherein, the computer cursor control device operates in the mouse mode and the multimedia mode via the hub.

14. The computer cursor control device according to claim 13, the interface unit comprises a card reader interface.

15. The computer cursor control device according to claim 14, further comprising a memory card used for connecting to the card reader interface and storing the multimedia file.

16. The computer cursor control device according to claim 13, wherein the multimedia module comprises a multimedia controller, a code conversion unit, and a memory unit.

17. The computer cursor control device according to claim 16, wherein the memory unit stores the multimedia file.

18. The computer cursor control device according to claim 13, wherein the button control unit comprises a cursor control circuit and a multimedia control circuit.

19. The computer cursor control device according to claim 13, wherein the mouse module comprises a mouse controller and a direction sensing unit.
